(19) United States
(12) Patent Application Publication
(10) Pub. No.: US 2009/0102782 A1
(43) Pub. Date: Apr. 23, 2009

(54) BACKLIGHT APPARATUS

(75) Inventors: Chi-Hsiu Lin, Yunlin County (TW); Shin-Chang Lin, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/199,809

(22) Filed: Aug. 28, 2008

(30) Foreign Application Priority Data
Oct. 18, 2007 (TW) 96139006

(51) Int. Cl. G09G 3/36

(52) U.S. Cl. 345/102

(57) ABSTRACT

A backlight apparatus is provided. The apparatus includes a light emitting unit, a voltage converter, a voltage detection unit, a correction unit, and a feedback control unit. The light emitting unit has a first connection end and a second connection end. The voltage converter transforms an input voltage into a rated voltage according to a periodic signal. The voltage detection unit detects a voltage level on the first connection end and the second connection end, and generates a measuring voltage. The correction unit performs a gain correction of the measuring voltage and adjusts the corrected measuring voltage by a specific ratio to generate a correction voltage. The feedback control unit outputs a feedback signal according to the correction voltage, and the voltage converter dynamically modifies the periodic signal according the feedback signal.

### CROSS-REFERENCE TO RELATED APPLICATION

This application claims the priority benefit of Taiwan application serial no. 96139006, filed on Oct. 18, 2007. The entirety of the above-mentioned patent application is hereby incorporated by reference herein and made a part of specification.

### BACKGROUND OF THE INVENTION

1. Field of the Invention

The present invention relates to a backlight apparatus of a display, and in particular, to a backlight apparatus for dynamically correcting a driving voltage of a light emitting diode.

2. Description of Related Art

Liquid crystal displays (LCD) are the mainstream products in the display market. Due to the advantageous features provided by the LCDs, namely, high definition, low power consumption, thinness and massive production, a low operating voltage, small and compact size, LCDs have become the mainstream display screens of the products including small portable TVs, image phones, digital camcorders, digital players, notebooks, desktop computers, and LCD TVs.

LCDs mainly include LCD panels, backlight modules and frames. Light emitted from the back light modules is one important factor for deciding the color saturation and the brightness of LCDs. FIG. 1 is a schematic view illustrating the structure of a conventional backlight apparatus 100. Referring to FIG. 1, the backlight apparatus 100 includes a voltage converter 110 and light emitting units 120a˜120n. The light emitting units 120a˜120n are electrically connected to the voltage converter 110. The light emitting unit 120a includes M light emitting diodes (LEDs) D₁₁˜D_{M1}, a switch SW1 and a constant current source CS1, wherein M is an integral greater than 0. Similarly, the aforementioned can be applied to the light emitting units 120b˜120n for knowing inner components thereof.

In order to describe the problem of the conventional backlight apparatus 100, please refer to the following descriptions regarding the structure of the conventional backlight apparatus 100 shown in FIG. 2. Referring to FIG. 2, after an input voltage V₁₁ is received by the voltage converter 110 from an input end thereof, the voltage converter 110 transforms an input voltage V₁₁ into a rated voltage V_{O1} according to an inner periodic signal and then transmits the rated voltage V_{O1} to the light emitting unit 120a. When the switch SW1 in the light emitting unit 120a is turned on, the light emitting unit 120a drives the LEDs D₁₁˜D_{M1} inside to illuminate by using the rated voltage V_{O1} and adjusts the brightness of the LEDs D₁₁˜D_{M1} by using the internal constant current source CS1.

Because the voltage converter 110 determines the value of the rated voltage V_{O1} according to the inner periodic signal, the rated voltage V_{O1} is fixed when the periodic signal is fixed. However, the forward voltages of the LEDs D₁₁˜D_{M1} increase or decrease as the temperature of the system increases or decreases. In other words, the voltage difference between two ends of each of the LEDs D₁₁˜D_{M1} is reduced. Therefore, extra voltage will be absorbed by the switch SW1 and release energy in the form of heat by turning on or off the switch SW1, thereby leading to increase of temperature and waste of power.

For example, referring to FIG. 2, the LED D₁₁ has a forward voltage V₁₁, and the LED D₂₁ has a forward voltage V₁₂. Likewise, the aforementioned example can be applied to the rest of LEDs D₃₁˜D_{M1}. Furthermore, the voltage difference between two ends of the switch SW1 is V_{SW1}, and the voltage difference between two ends of the constant current source CS1 is V_{C1}. Therefore, the first equation V_{O1}=V₁₁+ . . . +V_{1M}+V_{S} and a second equation V_{S}=V_{SW1}+V_{C1} are obtained. According to the first equation, when the temperatures of the LEDs D₁₁˜D_{M1} increase as the forward voltages V₁₁˜V_{1M} decrease, the voltage V_{S} increases and the rated voltage V_{O1} is fixed. According to the second equation, because the voltage V_{C1} is fixed, the increased value of the voltage V_{S} is completely absorbed by the switch SW1. Therefore, quite a lot energy dissipates in the form of heat (the energy loss of the switch occurs from conduction and the process of turning on/off the switch), which leads to the temperature increase of the system and extra power consumption. Thereby, the efficiency of the whole system are reduced.

### SUMMARY OF THE INVENTION

The present invention is directed to a backlight apparatus for solving a problem of a temperature increase of a switch. The problem is caused by an extra voltage absorbed by the switch when the temperature of a light emitting diode (LED) increases as a forward voltage thereof decreases.

The present invention is directed to a backlight apparatus which can reduce power consumption, prevent a temperature increase of the apparatus and improve an effect caused by a temperature increase of an LED, so that the whole efficiency can be greatly improved.

The present invention provides a backlight apparatus which includes a light emitting unit, a voltage converter, a voltage detection unit, a correction unit and a feedback control unit. The light emitting unit has a first connection end and a second connection end. The voltage converter transforms an input voltage into a rated voltage according to a periodic signal. The rated voltage drives the light emitting unit through the first connection end thereof.

The voltage detection unit is used for detecting a voltage level on the first connection end and the second connection end of the light emitting unit, so as to generate a measuring voltage. The correction unit is used for performing a gain correction of the measuring voltage and adjusting the corrected measuring voltage by a specific ratio to generate a correction voltage. The feedback control unit outputs a feedback signal according to the correction voltage, and the voltage converter dynamically modifies the periodic signal according to the feedback signal.

From another aspect, the present invention provides a backlight apparatus including N light emitting units, a voltage converter, N voltage detection units, a voltage comparing unit, a correction unit and a feedback control unit. Each of the light emitting units respectively has a first connection end and a second connection end, and N is an integral greater than 0. The voltage converter transforms an input voltage into a rated voltage according to a periodic signal. The rated voltage drives each of the light emitting units to illuminate through the first connection end of each of the light emitting units.

Each of the N voltage detection units generates a measuring voltage. The i^{th} voltage detection unit among the N voltage detection units is used for detecting a voltage level on the two connection ends of the i^{th} light emitting unit, so as to generate the i^{th} measuring voltage. The abovementioned i is an integral and 1≦i≦N. The voltage comparing unit is used for comparing the measuring voltages generated by the N voltage detection units and selecting one of the measuring voltages to output as a maximum measuring voltage according to the comparison result.

The correction unit is used for performing a gain correction of the measuring voltage and adjusting the corrected measuring voltage by a specific ratio to generate a correction voltage. The feedback control unit outputs a feedback signal according to the correction voltage, and the voltage converter dynamically modifies the periodic signal according to the feedback signal.

The present invention adopts the design of a feedback circuit, so that the voltage converter can dynamically modify the inner periodic signal according to a feedback signal and changes the outputted rated voltage. Therefore, the disadvantages in the prior arts can be effectively improved, and the temperature of the switch is prevented from increasing. In addition, by adjusting the rated voltage dynamically, the power consumption is reduced, the temperature of the apparatus is prevented from increasing, and therefore the whole efficiency can be greatly improved.

In order to make the aforementioned and other objects, features and advantages of the present invention more comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating the structure of a conventional backlight apparatus 100.

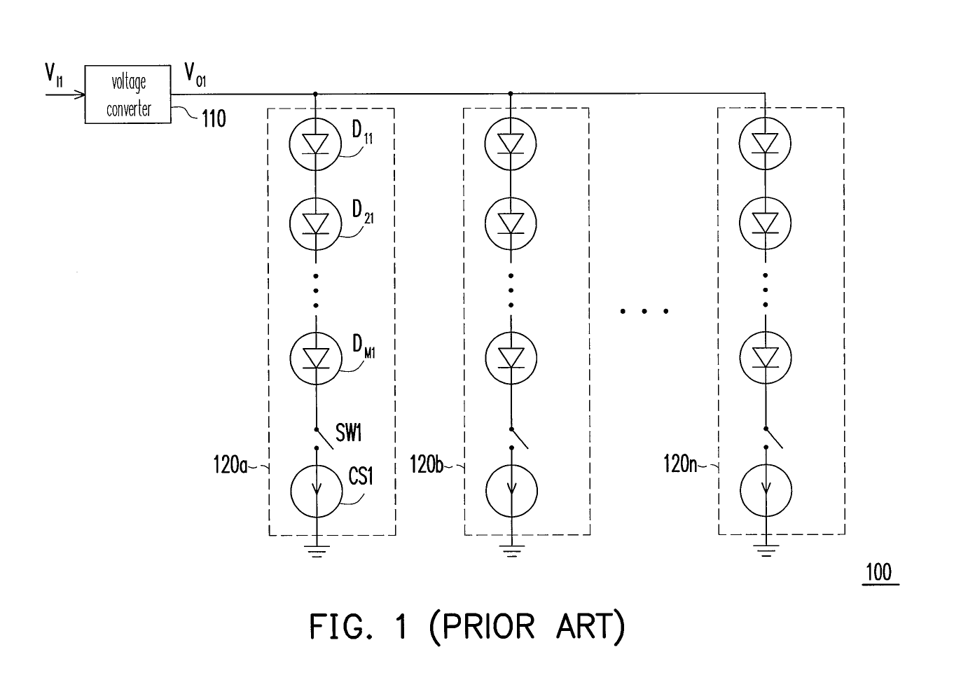

FIG. 2 is a schematic view illustrating the partial structure of the conventional backlight apparatus 100.

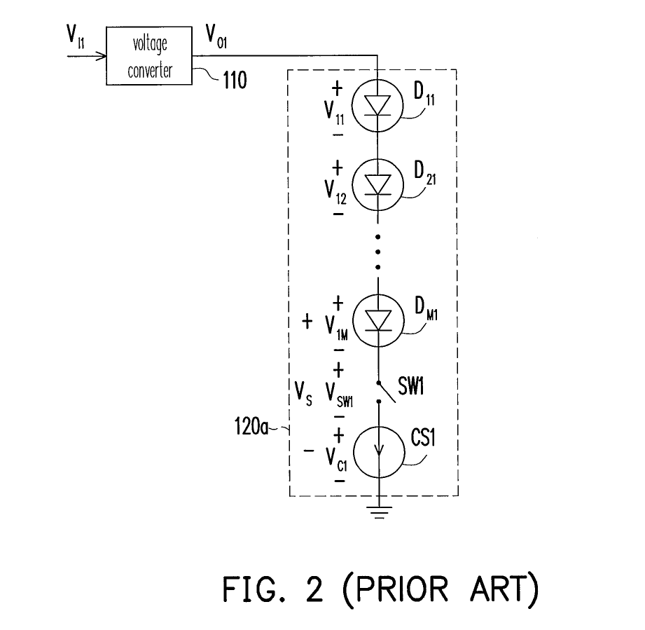

FIG. 3A is a schematic view illustrating the structure of a backlight apparatus 300 according to an embodiment of the present invention.

FIG. 3B is a schematic view illustrating the structure of the backlight apparatus 300 using another type of a voltage detection unit.

FIG. 4A is a schematic view illustrating the structure of a backlight apparatus 400 according to another embodiment of the present invention.

FIG. 4B is a schematic view illustrating the structure of the backlight apparatus 400 using another type of the voltage detection unit.

### DESCRIPTION OF EMBODIMENTS

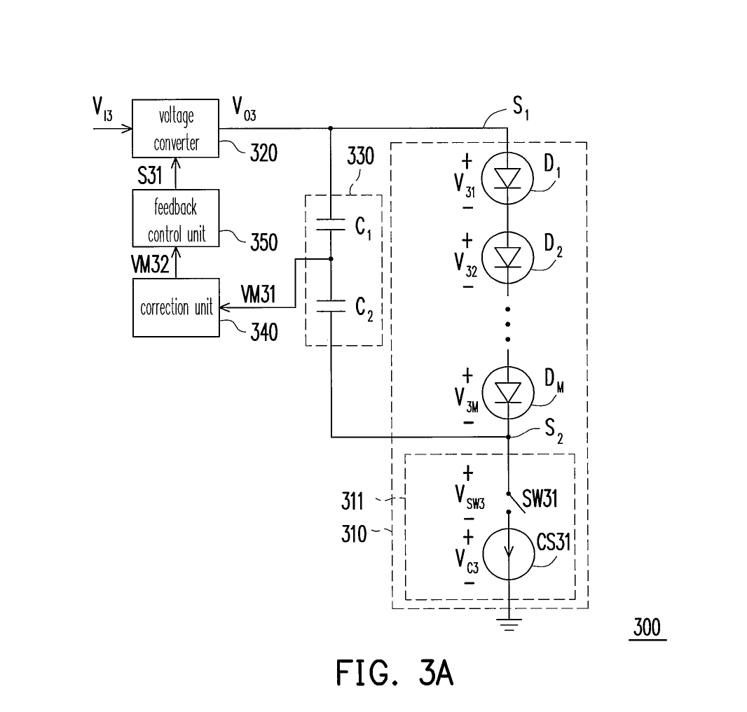

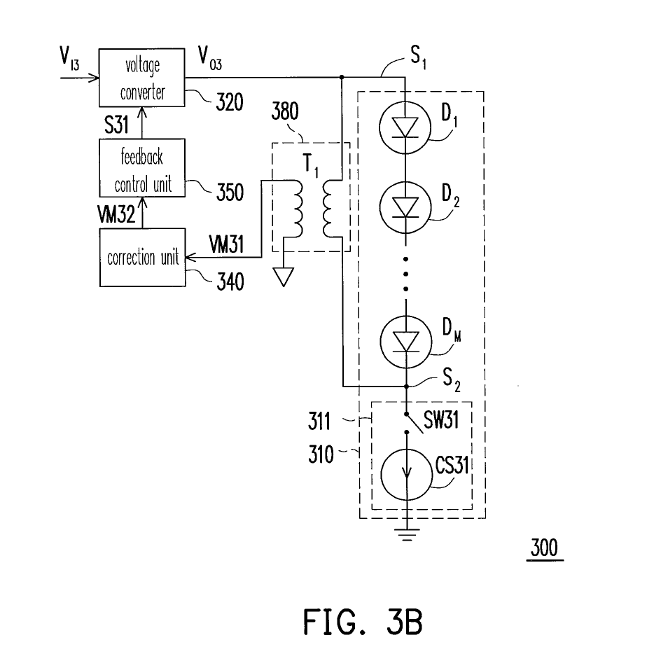

FIG. 3A is a schematic view illustrating the structure of a backlight apparatus 300 according to an embodiment of the present invention. Referring to FIG. 3A, the backlight apparatus 300 includes a light emitting unit 310, a voltage converter 320, a voltage detection unit 330, a correction unit 340, and a feedback control unit 350. The light emitting unit 310 has a first connection end S₁ and a second connection end S₂. The first connection end S₁ is electrically connected to an output end of the voltage converter 320 while the second connection end S₂ is electrically connected to the voltage detection unit 330.

The voltage detection unit 330 is electrically connected between the first connection end S₁ and the second connection end S₂ to detect a voltage level of the two connection ends, so as to generate a measuring voltage VM31. The correction unit 340 is electrically connected to the voltage detection unit 330 and the feedback control unit 350 in order to correct the measuring voltage VM31 and adjust the corrected measuring voltage VM31 by a specific ratio, so as to generate a correction voltage VM32. The feedback control unit 350 is electrically connected to the voltage converter 320 to output a feedback signal S31 to the voltage converter 320 according to the correction voltage VM32.

The light emitting unit 310 includes a plurality of light emitting devices D₁˜D_{M} and a current generating unit 311, wherein M is an integral greater than 0. The light emitting devices D₁˜D_{M} are electrically connected in series between the first connection end S₁ and the second connection end S₂. The light emitting devices D₁˜D_{M} are respectively comprised by a light emitting diode (LED). A first end (i.e. anode) of the light emitting device D₁ is electrically connected to the first connection end S₁. A second end (i.e. cathode) of the light emitting device D_{M} is electrically connected to the second connection end S₂.

Moreover, the current generating unit 311 is electrically connected between the second connection end S₂ and the ground terminal. The current generating unit 311 includes a switch SW31 and a constant current source CS31. One end of the switch SW31 is electrically connected to the second connection end S2, and the other end of the switch SW31 is electrically connected to one end of the constant current source CS31. The other end of the constant current source CS31 is electrically connected to the ground terminal. The current generating unit 311 adjusts the current passing through the light emitting devices D₁˜D_{M} according to a control signal. In other words, the switch SW31 will determine a conductive state thereof according to the control signal, so as to control the current provided by the constant current source CS31 to pass through the light emitting devices D₁˜D_{M} or not.

The voltage detection unit 330 includes capacitors C₁ and C₂. A first end of the capacitor C₁ is electrically connected to the first connection end S₁. A second end of the capacitor C₁ is used for outputting the measuring voltage VM31. A first end of the capacitor C₂ is electrically connected to the second end of the capacitor C₁ and a second end of the capacitor C₂ is electrically connected to the second connection end S₂.

Referring to FIG. 3A, the voltage converter 320 amplifies or minifies an input voltage V_{I3} according to the inner periodic signal after receiving the input voltage V_{I3} in order to transform the input voltage V_{I3} into a rated voltage V_{O3}. After the switch SW31 is turned on according to the control signal, the light emitting unit 301 drives the light emitting devices D₁˜D_{M} inside by using the rated voltage V_{O3} provided by the voltage converter 320, and adjusts the brightness of the light emitting devices D₁˜D_{M} by adjusting the constant current source CS31.

It is assumed that the light emitting device D₁ has a forward voltage V₃₁, the light emitting device D_{M} has a forward voltage V_{3M} and the rest of forward voltages can be similarly derived. Likewise, the aforementioned can be applied to the rest of the light emitting devices for knowing the numbering priniciple of forward voltages thereof. It is also assumed that a voltage difference caused by the switch SW31 is represented as V_{SW3}, and a voltage difference caused by the constant current source CS31 is represented as V_{C3}. The forward voltages of the light emitting devices D₁˜D_{M} decrease as the temperatures in itself increase. Then, when the forward voltages V_{f1}˜V_{fM} decrease, the voltage detection unit 330 obtains a voltage variation between the first connection end S₁ and the second connection end S₂, so as to generate a measuring voltage VM31 and transmit the measuring voltage VM31 to the correction unit 340.

After receiving the measuring voltage VM31, the correction unit 340 performs a gain correction of the measuring voltage VM31 and adjusts the corrected measuring voltage VM31 by a specific ratio to generate a correction voltage VM32. In other words, after detecting the voltage level between the first connection end S₁ and the second connection end S₂, the correction unit 340 subtracts the voltage level detected at this moment from the voltage level detected previously to obtain a voltage variation. After that, the correction unit 340 performs a mathematical non-linear operation on the voltage variation to generate the corrected voltage VM32 and output the corrected voltage VM32 to the feedback control unit 350.

The feedback control unit 350 generates a feedback signal S31 according to the corrected voltage VM32 and transmits the feedback signal S31 to the voltage converter 320 after the feedback control unit 350 receives the corrected voltage VM32. In other words, the feedback control unit 350 generates the feedback signal S31 by converting the unit of the received corrected voltage VM32. Moreover, after the voltage converter 320 receives the feedback signal S31, the voltage converter 320 adjusts the periodic signal inside according to the feedback signal S31 to change the outputted rated voltage V_{O3}. For example, the voltage converter 320 adjusts the input voltage V_{I3} by a specific ratio according to the periodic signal inside to generate the rated voltage V_{O3}. However, after receiving the feedback signal S31, the voltage converter 320 performs an addition or subtraction operation between the feedback signal S31 and the periodic signal S31 to generate a new periodic signal and thereby corrects and adjusts the specific ratio for amplifying or minifying the input voltage V_{I3}.

The coupling relationship between the voltage converter 320, the voltage detection unit 330, the correction unit 340 and the feedback control unit 350 is regarded as a feedback circuit. The backlight apparatus 300 can adjust the rated voltage V_{O3} anytime by the feedback circuit. Therefore, the voltage detection unit 330 can generate a feedback signal S31 immediately after obtaining variations of the forward voltages of the light emitting devices D₁˜D_{M} to correct the periodic signal inside the voltage converter 320, so as to change the rated voltage V_{O3}, and thereby prevents the voltage V_{SW3} of the switch SW31 from increasing. Furthermore, because the forward voltages of the light emitting devices D₁˜D_{M} do not decrease linearly as the temperatures thereof increase, the correction unit 340 performs the gain correction of the measuring voltage VM31 and adjusts the corrected measuring voltage VM31 by performing a non-linear operation in order to meet the actual requirement of the system.

It should be mentioned that the structure of the voltage detection unit 330 in the backlight apparatus 300 is not limited to the abovementioned. For example, FIG. 3B is a schematic view illustrating the backlight apparatus 300 using another type of the voltage detection unit. A voltage detection unit 380 is used to replace the voltage detection unit 330 in FIG. 3A. Referring to FIG. 3B, the voltage detection unit 380 includes a transformer T₁. The transformer T₁ has a primary side and a secondary side. A first end of the primary side is electrically connected to the first connection end S₁ of the light emitting unit 310, a second end of the primary side is electrically connected to the second connection end S₂ of the light emitting unit 310, a first end of the secondary side is used for generating the measuring voltage VM31, and a second end of the secondary side is electrically connected to a ground terminal.

Continued from the preceding paragraph, through the aforesaid coupling relationship in regard to the transformer T₁, the voltage detection unit 380 can have a function the same or similar to that of the voltage detection unit 330 constituted by the capacitors. Accordingly, it should be known by those skilled in the art that the voltage detection unit in the backlight apparatus 300 is not limited to the aforesaid embodiments, and users can use an amplifier for designing a circuit having a function the same or similar to that of the voltage detection unit.

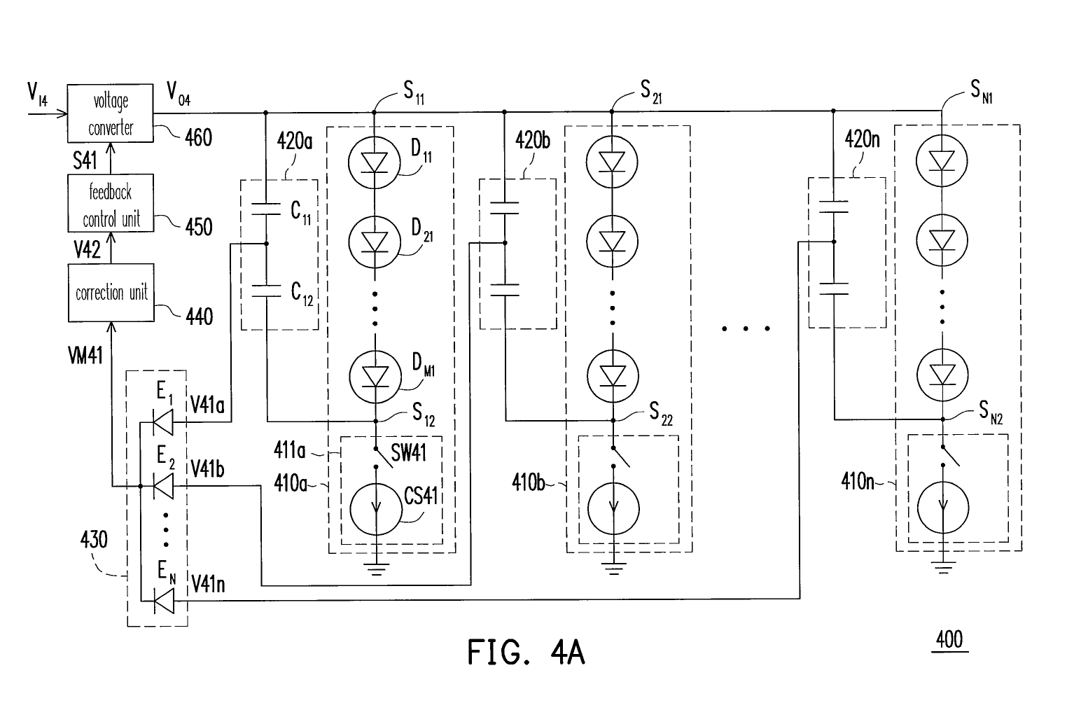

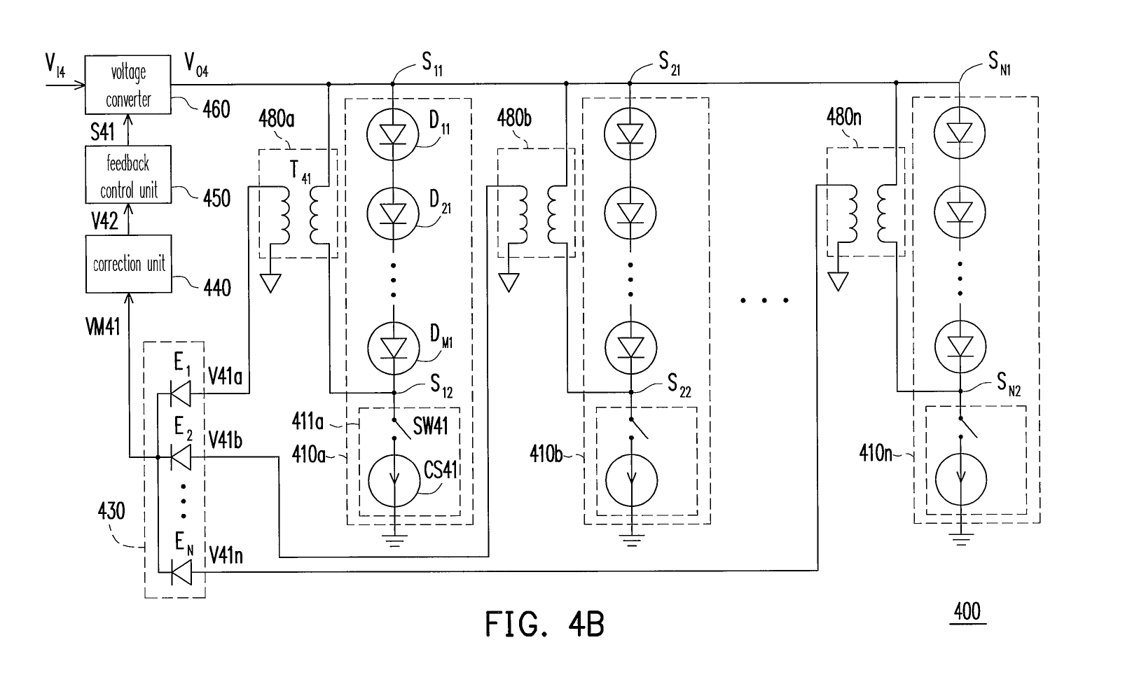

FIG. 4A is a schematic view illustrating the structure of a backlight apparatus 400 according to another embodiment of the present invention. Referring to FIG. 4A, a backlight apparatus 400 includes N light emitting units 410a˜410n, a voltage converter 460, N voltage detection units 420a˜420n, a voltage comparing unit 430, a correction unit 440 and a feedback control unit 450, wherein N is an integral greater than 0. Light emitting units 410a˜410n respectively have a first connection end and a second connection end. For example, the light emitting unit 410a has a first connection end S₁₁ and a second connection end S₁₂, the light emitting unit 410b has a first connection end S_{N1} and a second connection end S_{N2}, and the light emitting units 410c˜410n can be similarly derived. The first connection ends S₁₁S_{N1} of the light emitting units 410a˜410ₙ are electrically connected to the output end of the voltage converter 460, and the second connection ends of the light emitting units 410a˜410n are electrically connected to the corresponding voltage detection units 420a˜420n.

The voltage detection units 420a˜420n are electrically connected between the corresponding first connection ends S₁₁˜S_{N1} and the second connection ends S₁₂˜S_{N2}. For example, the voltage detection unit 420a is electrically connected between the first connection end S₁₁ and the second connection end S₁₂, and the voltage detection unit 420n is electrically connected between the first connection end S_{N1} and the second connection end S_{N2}. Furthermore, the voltage detection units 420a˜420n are used for detecting a voltage level of the two connection ends to generate a measuring voltage respectively. For example, the voltage detection unit 420a is electrically connected between the first connection end S₁₁ and the second connection end S₁₂ to detect the voltage level of the two connection ends, so as to generate a measuring voltage V41a accordingly. The voltage comparing unit 430 is electrically connected to the voltage detection units 420a˜420n for comparing the voltage of the measuring voltages V41a˜V41n, so as to select one of the measuring voltages V41a˜V41n to output as a maximum measuring voltage VM41 according to the comparison result.

The correction unit 440 is electrically connected to the voltage comparing unit 430 and the feedback control unit 450. The feedback control unit 450 is electrically connected to the voltage converter 460. The correction unit 440 and the voltage comparing unit 430 have functions the same to those described in the aforesaid embodiments,.and therefore the detailed description is not repeated.

Referring to FIG. 4A, according to the present embodiment, the structure and the function of the backlight apparatus 400 are similar to those described in the aforesaid embodiments except the numbers of the voltage comparing units, the light emitting units and the voltage detection units. Therefore, the spirit of the present embodiment is described mainly in accordance with the units 410a˜410n, 420a˜420n and 430.

Each of the light emitting units 410a˜410n includes M light emitting devices and a current generating unit, wherein M is an integral greater than 0. For example, the light emitting unit 420a includes light emitting devices D₁₁˜D_{M1} and the current generating unit 411a, and the inner components included by the light emitting units 410b˜410n can be similarly derived. The current generating unit 411a includes a switch SW41 and a constant current source CS41, and adjusts current passing through the light emitting devices D₁₁˜D_{M1} according to a control signal. In other words, the switch SW41 determine a conductive state thereof according to the control signal, so as to control the current provided by the constant current source CS41 to pass through the light emitting devices D₁˜D_{M} or not.

Each of the voltage detection units 420a˜420n includes two capacitors connected electronically connected in series between the corresponding first connection end and the second connection end. For example, the voltage detection unit 420a includes capacitors C₁₁ and C₁₂, wherein a first end of the capacitor C₁₁ is electrically connected to the first connection end S₁₁, a second end of the capacitor is electrically connected to a first end of the capacitor C₁₂, a second end of the capacitor C₁₂ is electrically connected to the second connection end S₁₂, and the first end of the capacitor C₁₂ is used to generate a measuring voltage V41a. Similarly, the aforementioned example regarding the voltage detection unit 420a can be applied to the rest voltage detection units 420b˜420n for knowing components thereof and the coupling relationship of the components.

The voltage comparing unit 430 includes N diodes E₁˜E_{N}, wherein an anode of each of the diodes is electrically connected to the corresponding voltage detection unit (e.g. the anode of the diode E₁ is electrically connected to the voltage detection unit 420a) while a cathode of each of the diodes E₁˜E_{N} is electrically connected to the correction unit 440.

Referring to FIG. 4A, because the forward voltages of the light emitting units 420a˜420n may decrease as the temperatures in itself, each of the voltage detection units obtains a corresponding measuring voltage. Therefore, N voltage detection units 420a˜420n have N measuring voltages V41a˜V41n. The voltage comparing unit 430 then receives and compares the measuring voltages V41a˜V41n. After that, according to the comparison result, the voltage comparing unit 430 selects one of the measuring voltages V41a˜V41n to output as a maximum measuring voltage VM41.

For example, if the voltage comparing unit 430 includes diode E₁ and E₂ only, the diode E₁ receives the measuring voltage V41a of 2 volts, and the diode E₂ receives the measuring voltage V41b of 1 volt, then the cathode of the diode E₁ receives the voltage of 2 V, so that the voltage of 1V received by the diode E₂ can not pass, and therefore the maximum measuring voltage obtained according to the principle is 2V.

After obtaining the maximum measuring voltage VM41, the following steps are similar to those described in aforementioned embodiment. The correction unit 440 performs a gain correction of the maximum measuring voltage VM41 and adjusts the corrected maximum voltage by a specific ratio to generate a correction voltage V42 and transmit the correction voltage V42 to the feedback control unit 450. The feedback control unit 450 generates a feedback signal S41 according to the correction voltage V42 in order to modify the periodic signal of the voltage converter 460, and thereby changes the rated voltage V_{O4}.

It should be mentioned that the structure of the voltage detection units 420a˜420n in the backlight apparatus 400 is not limited to the abovementioned. For example, FIG. 4B is a schematic view illustrating the structure of the backlight apparatus 400 using another type of the voltage detection unit. Voltage detection units 480a˜480n are used to replace the voltage detection units 420a˜420n in FIG. 4A. Referring to FIG. 4B, each of the voltage detection units 480a˜480n includes a transformer, wherein a transformer T₄₁ has a primary side and a secondary side. A first end of the primary side is electrically connected to the first connection end S₁₁ of the light emitting unit 410a while a second end of the primary side is electrically connected to the second connection end S₁₂ of the light emitting unit 410a. A first end of the secondary side is used to generate a measuring voltage V41a, and a second end of the secondary side is electrically connected to a ground terminal. Similarly, the aforementioned example regarding the voltage detection unit 480a can be applied to the rest voltage detection units 480b˜480n for knowing inner components thereof and the coupling relationship of the inner components.

Continued from the preceding paragraph, by utilizing the coupling relationship of the transformer T₄₁, the voltage detection units 480a˜480n can have a flnction the same or similar to that of the voltage detection units 420a˜420n constituted by the capacitors. Accordingly, it should be known by those skilled in the art that the voltage detection units in the backlight apparatus 400 are not limited to those described in the aforesaid embodiments.

In summary, according to the present invention, by using the design of the feedback circuit, the voltage converter can correct the periodic signal inside according to a feedback signal, so as to change the output rated voltage, thereby preventing the voltage of the switch from increasing. Therefore, power consumption and the temperature of the apparatus are prevented from increasing, the status of the light emitting device is stabilized and the efficiency of the whole system is improved. Furthermore, the present invention can be utilized in the structure of any kind of the voltage converter, so that the present invention can be used extensively to enhance the competitiveness of the products.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A backlight apparatus, comprising:
a light emitting unit, having a first connection end and a second connection end;
a voltage converter, for transforming an input voltage into a rated voltage according to a periodic signal, wherein the rated voltage drives the light emitting unit to illuminate through the first connection end of the light emitting unit;
a voltage detection unit, for detecting the voltage levels on the first connection end and the second connection end of the light emitting unit, so as to generate a measuring voltage;
a correction unit, for performing a gain correction of the measuring voltage and adjusting the corrected measuring voltage by a specific ratio to generate a correction voltage; and
a feedback control unit, for outputting a feedback signal according to the correction voltage, wherein the voltage converter dynamically modifies the periodic signal according to the feedback signal.

2. The backlight apparatus according to claim 1, wherein the voltage detection unit comprises:
a first capacitor, having a first end electrically connected to the first connection end of the light emitting unit and a second end for generating the measuring voltage; and
a second capacitor, having a first end electrically connected to the second end of the first capacitor and a second end electrically connected to the second connection end of the light emitting unit.

3. The backlight apparatus according to claim 1, wherein the voltage detection unit comprises:
a transformer, having a primary side and a secondary side, wherein a first end of the primary side is electrically connected to the first connection end of the light emitting unit, a second end of the primary side is electrically connected to the second connection end of the light emitting unit, a first end of the secondary side generates the measuring voltage, and a second end of the secondary side is electrically connected to a ground terminal.

4. The backlight apparatus according to claim 1, wherein the light emitting unit comprises:
a plurality of light emitting devices, electrically connected in series between the first connection end and the second connection end of the light emitting unit; and
a current generating unit, electrically connected between the second connection end of the light emitting unit and a ground terminal for adjusting current passing through the light emitting devices according to a control signal.

5. The backlight apparatus according to claim 4, wherein the current generating unit comprises:
a switch, having a first end electrically connected to the second connection end of the light emitting unit, for determining a conductive state thereof according to the control signal; and
a constant current source, electrically connected between a second end of the switch and the ground terminal.

6. The backlight apparatus according to claim 4, wherein the light emitting devices are respectively comprised by a light emitting diode.

7. A backlight apparatus, comprising:
N light emitting units, wherein each of the light emitting units respectively has a first connection end and a second connection end, and N is an integral greater than 0;
a voltage converter, for transforming an input voltage into a rated voltage according to a periodic signal, wherein the rated voltage drives the light emitting units to illuminate through the first connection end of each of the light emitting units;
N voltage detection units, for generating N measuring voltages, wherein the i^{th} voltage detection unit detects a voltage level on two connection ends thereof, so as to generate the i^{th} measuring voltage, wherein i is an integral and 1≦i≦N;
a voltage comparing unit, for comparing the measuring voltages and selecting one of the measuring voltages to output as a maximum measuring voltage according to a comparison result;
a correction unit, for performing a gain correction of the maximum measuring voltage and adjusting the corrected maximum measuring voltage by a specific ratio to generate a correction voltage; and
a feedback control unit, for outputting a feedback signal according to the correction voltage, wherein the voltage converter dynamically modifies the periodic signal according to the feedback signal.

8. The backlight apparatus according to claim 7, wherein the voltage comparing unit comprises:
N diodes, an anode of the i^{th} diode electrically connected to the i^{th} voltage detection unit, and a cathode of each of the diodes electrically connected to the correction unit.

9. The backlight apparatus according to claim 7, wherein the i^{th} voltage detection unit comprises:
a first capacitor, having a first end electrically connected to the first connection end of the i^{th} light emitting unit and a second end for generating the i^{th} measuring voltage; and
a second capacitor, having a first end electrically connected to the second end of the first capacitor and a second end electrically connected to the second connection end of the i^{th} light emitting unit.

10. The backlight apparatus according to claim 7, wherein the i^{th} voltage detection unit comprises:
a transformer, having a primary side and a secondary side, a first end of the primary side electrically connected to the first connection end of the i^{th} light emitting unit, a second end of the primary side electrically connected to the second connection end of the i^{th} light emitting unit, a first end of the secondary side for generating the i^{th} measuring voltage, and a second end of the secondary side electrically connected to a ground terminal.

11. The backlight apparatus according to claim 7, wherein the i^{th} light emitting unit comprises:
a plurality of light emitting devices, electrically connected in series between a first connection end and a second connection end of the i^{th} light emitting unit; and
a current generating unit, electrically connected between the second connection end of the i^{th} light emitting unit and a ground terminal to adjust current passing through the light emitting devices according to a control signal.

12. The backlight apparatus according to claim 11, wherein the current generating unit comprises:
a switch, having a first end electrically connected to the second connection end of the i^{th} light emitting unit, and for determining a conductive state of the switch according to the control signal; and
a constant current source, electrically connected between a second end of the switch and the ground terminal.

13. The backlight apparatus according to claim 11, wherein the light emitting devices are respectively comprised by a light emitting diode.
